(19) United States
(12) Patent Application Publication
(10) Pub. No.: US 2024/0326211 A1
(43) Pub. Date: Oct. 3, 2024

(54) Pounding, Prying, And Screwing Hand Tool And Method Of Use

(71) Applicants: Roberto Morales, St Peters, MO (US); Jesse Ray, St Peters, MO (US)

(72) Inventors: Roberto Morales, St Peters, MO (US); Jesse Ray, St Peters, MO (US)

(21) Appl. No.: 18/130,411

(22) Filed: Apr. 3, 2023

(51) Int. Cl. B25D 1/04; B25B 15/00

(52) U.S. Cl. CPC B25D 1/04; B25B 15/004

(57) ABSTRACT

A pounding, prying, and screwing hand tool for setting a screw and creating a dimple therearound includes a hammerhead, which is attached to a first end of a handle. A screw bit is attached to, or is selectively attachable to, a second end of the handle so that the screw bit extends axially from the handle. The handle can be grasped in a hand of a user, positioning the user to set a respective screw into a sheet of drywall using the screw bit and to selectively impart a dimple into the sheet of drywall by pounding the screw using a rounded face of the hammerhead.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to multipurpose hand tools and more particularly pertains to a new multipurpose hand tool for setting a screw and creating a dimple therearound. The present invention discloses a multipurpose hand tool comprising a handle having a hammerhead attached to one end and a screw bit to the other.

### (2) Description of Related Art Including Information Disclosed Under 37 CFR 1.97 and 1.98

The prior art relates to multipurpose hand tools, which may comprise multipurpose hammers, such as hammers having modified claws for punching out knock-out plugs of electrical boxes and hammers with pick in place of their claws and having nail claws and prying claws attached to distal ends of their handles. The prior art does not teach a multipurpose hand tool comprising a handle having a hammerhead attached to one end and a screw bit to the other.

### BRIEF SUMMARY OF THE INVENTION

An embodiment of the disclosure meets the needs presented above by generally comprising a hammerhead, which is attached to a first end of a handle. A screw bit is attached to, or is selectively attachable to, a second end of the handle so that the screw bit extends axially from the handle. The handle is configured to be grasped in a hand of a user, positioning the user to selectively pound and to pry using the hammerhead and to selectively set a respective screw using the screw bit.

Another embodiment of the disclosure include a method of setting a screw and dimpling a sheet of drywall. The method comprises provision steps, which entail providing a pounding, prying, and screwing hand tool, according to the disclosure above, and a sheet of drywall having at least one screw requiring setting and around which a dimple is required for receiving joint compound. Operational steps of the method are setting the screw using the screw bit and imparting a dimple into the sheet of drywall using a rounded face of the hammerhead.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a pounding, prying, and screwing hand tool according to an embodiment of the disclosure.

FIG. 2 is a side view of an embodiment of the disclosure.

FIG. 3 is a front view of an embodiment of the disclosure.

FIG. 4 is a bottom view of an embodiment of the disclosure.

FIG. 5 is a cross-sectional view of an embodiment of the disclosure.

FIG. 6 is an exploded view of an embodiment of the disclosure.

FIG. 7 is an in-use view of an embodiment of the disclosure.

FIG. 8 is an in-use view of an embodiment of the disclosure.

FIG. 9 is a flow diagram for a method utilizing an embodiment of the disclosure.

### DETAILED DESCRIPTION OF THE INVENTION

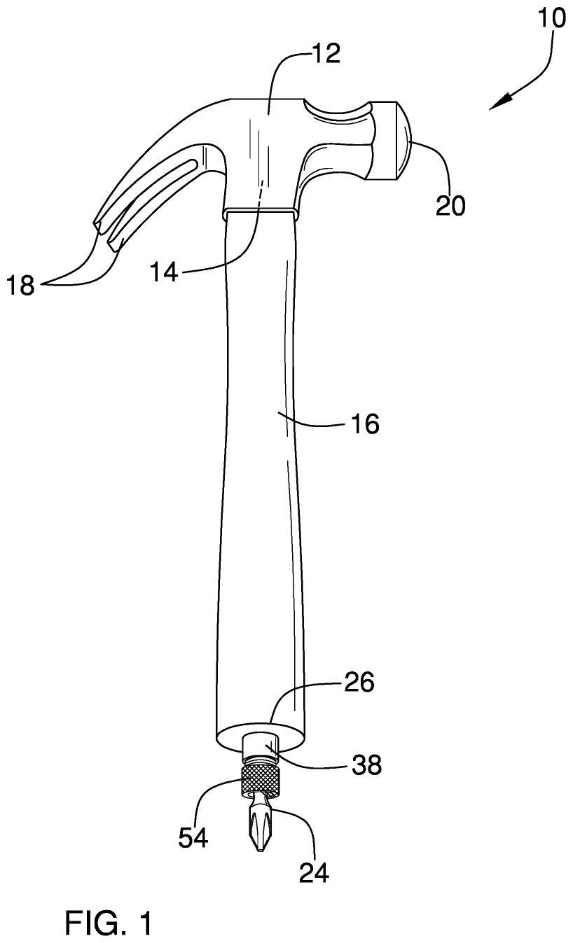

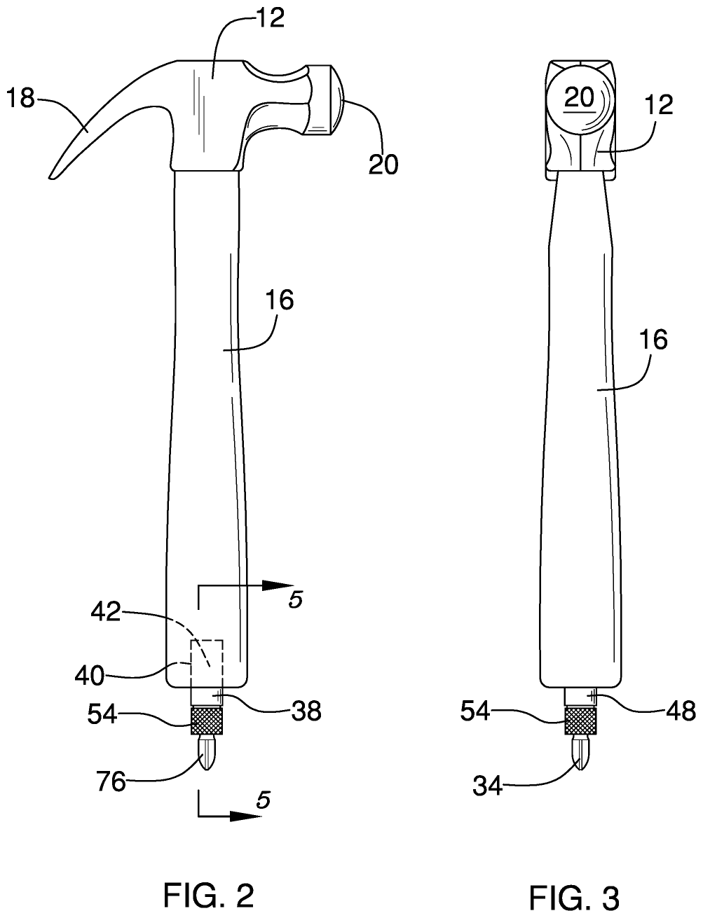

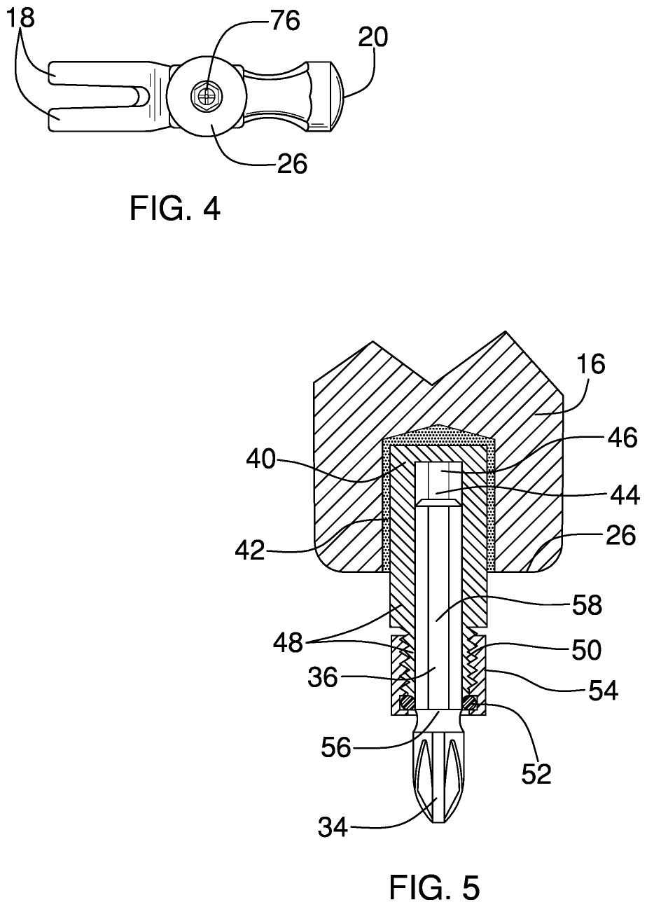

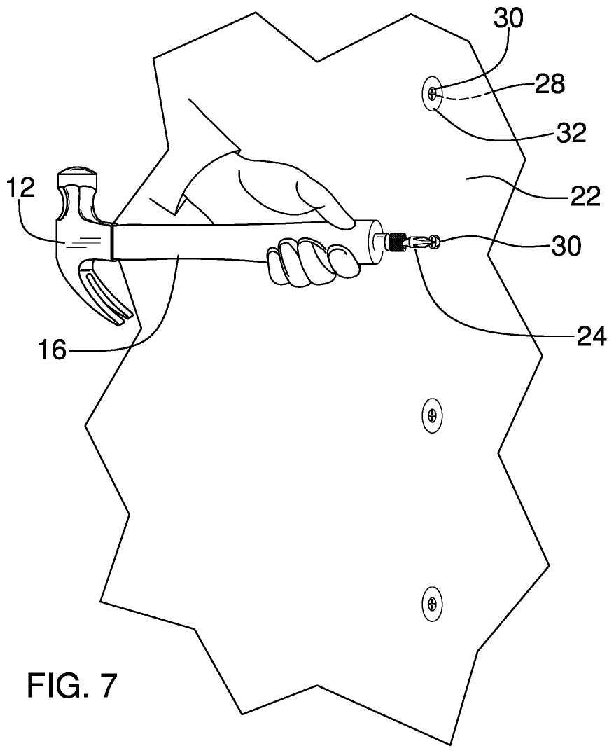

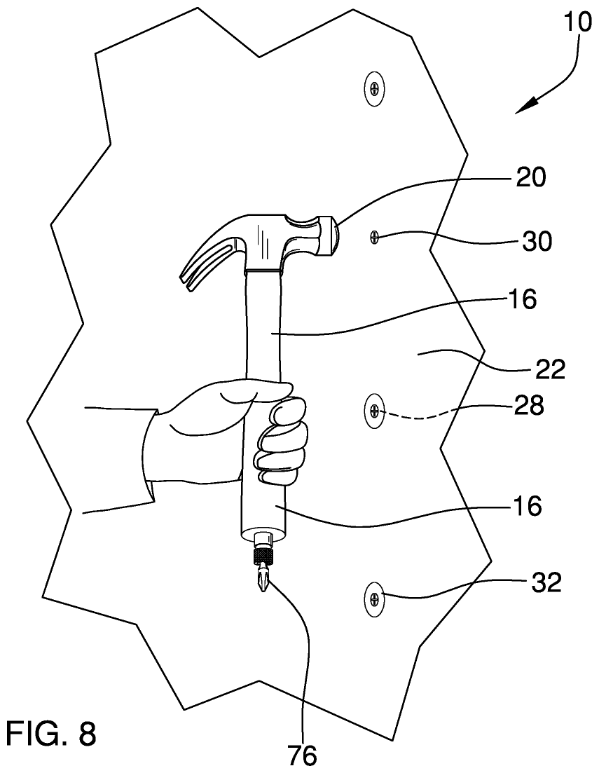

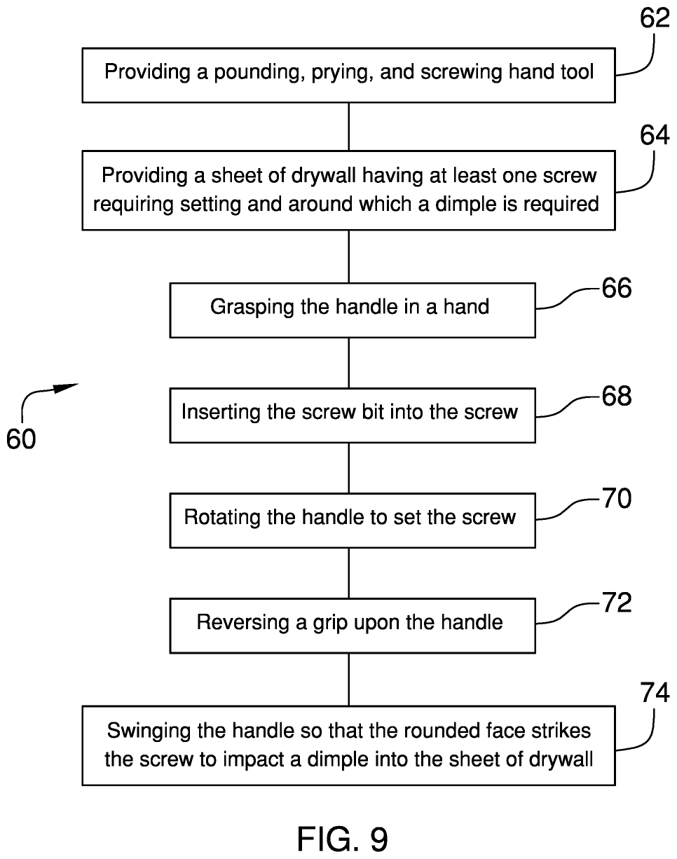

With reference now to the drawings, and in particular to FIGS. 1 through 9 thereof, a new multipurpose hand tool embodying the principles and concepts of an embodiment of the disclosure and generally designated by the reference numeral 10 will be described.

As best illustrated in FIGS. 1 through 9, the pounding, prying, and screwing hand tool 10 generally comprises a hammerhead 12, which is attached to a first end 14 of a handle 16. The hammerhead 12 comprises a claw 18, which is opposingly positioned relative to a rounded face 20. The handle 16 is configured to be grasped in the hand of the user, positioning the user to selectively dimple a sheet of drywall 22, using the rounded face 20, and to remove fasteners, such as nails and screws, by prying with the claw 18. The hammerhead 12 in this respect is similar to prior art hammerheads of what are known as drywall hammers.

As shown in FIG. 1, a screw bit 24 is attached to, or is selectively attachable to, a second end 26 of the handle 16 so that the screw bit 24 extends axially from the handle 16. The present invention also anticipates the screw bit 24 being selectively extensible from the second end 26 of the handle 16. Most usefully for setting a screw 28 in a sheet of drywall 22, the screw bit 24 comprises a Phillips head 76. The handle 16 is configured to be grasped in a hand of a user, positioning the user to selectively pound and to pry, using the hammerhead 12, and to selectively set a respective screw 28 using the screw bit 24.

Sheets of drywall 22 typically are installed using rotary tools, which are intended to drive a screw 28 through a sheet of drywall 22 and into a substrate, usually a wood stud, concurrently with creation of a dimple 32 around a head 30 of the screw 28. Inspection of the hung sheet of drywall 22 often will reveal screws 28 that are not properly set, which can arise due to an improper torque setting for the rotary tool, variations in substrate density, and the like. Correcting an improperly set screw 28 then requires a user to use a screwdriver to set the screw 28 and a drywall hammer to impress a dimple 32 into the sheet of drywall 22 around the head 30 of the screw 28. The pounding, prying, and screwing hand tool 10 allows the user to both set the screw 28 and to create the dimple 32, thereby increasing efficiency.

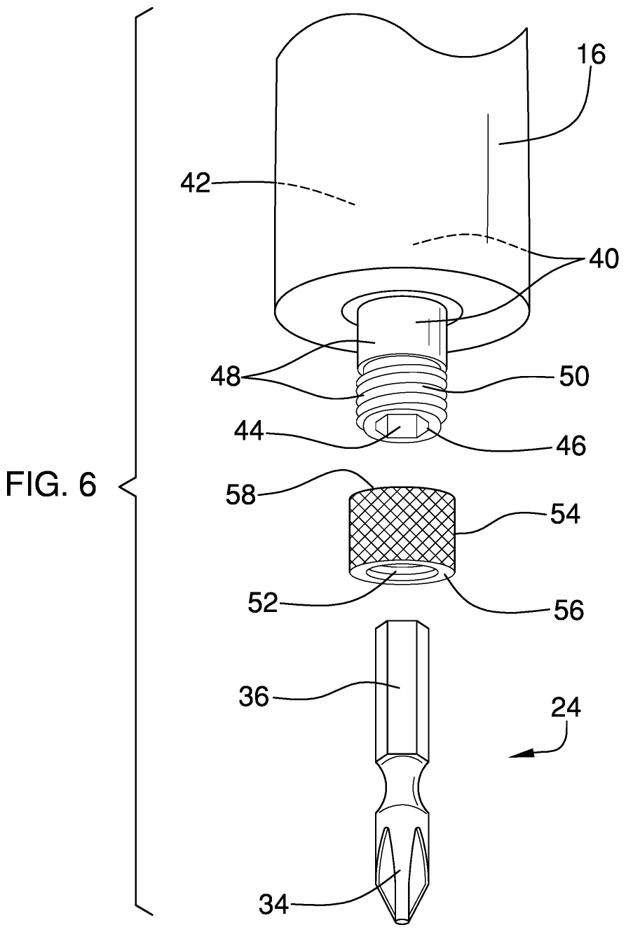

As shown in FIG. 6, the screw bit 24 comprises a bit section 34 and a coupling section 36, with the bit section 34 being complementary to the respective screw 28. A coupler 38, which is complementary to the coupling section 36 of the screw bit 24, is attached to the second end 26 of the handle 16. The coupler 38 is positioned to selectively couple to the coupling section 36 to removably attach the screw bit 24 to the handle 16.

As shown in FIG. 5, the coupler 38 comprises a tube 40, which is attached to the handle 16 and which is positioned in a channel 42 that extends into the handle 16. The tube 40 may be adhesively attached to the handle 16, or attached by other attachment means, such as, but not limited to, by means of external threading on the tube 40, captive fasteners, and the like. The tube 40 has an inner surface 44 with a hexagonal cross-sectional profile 46, which is complementary to the coupling section 36 of the screw bit 24. The present invention also anticipates the inner surface 44 have a square cross-sectional profile, or the like. The coupling section 36 of the screw bit 24 can be inserted into the tube 40 to attach the screw bit 24 to the handle 16, with attachment being enhanced by the coupler 38 being magnetic and the screw bit 24 being paramagnetic.

As the pounding, prying, and screwing hand tool 10 is used in pounding and prying, attachment of the screw bit 24 to the handle 16 by robust means is desirable. However, it also is desirable to have an ability to replace the screw bit 24 when it is worn down due to use. One such robust means includes a segment 48 of the tube 40 extending from the handle 16, with a portion 50 of the segment 48 distal from the handle 16 being externally threaded. An O-ring 52 is attached to and positioned in a collar 54 proximate to a first side 56 of the collar 54. The collar 54 is internally threaded and thus is complementary to the portion 50 of the segment 48 of the tube 40. The portion 50 of the segment 48 is threadedly insertable into a second side 58 of the collar 54 to compress the O-ring 52 between the collar 54 and the screw bit 24, thereby removably attaching the screw bit 24 to the tube 40.

The pounding, prying, and screwing hand tool 10 enables a method of setting a screw and dimpling a sheet of drywall 60. The method 60 comprises a first provision step 62, which entails providing a pounding, prying, and screwing hand tool, according to the specification above. A second provision step 64 of the method 60 is providing a sheet of drywall 22 having at least one screw 28 requiring setting and around which a dimple 32 is required for receiving joint compound. A first operational step 66 of the method 60 is grasping the handle 16 in a hand. A second operational step 68 and a third operational step 70 entail inserting the screw bit 24 into the screw 28 and rotating the handle 16 to set the screw 28, respectively. A fourth operational step 72 and a fifth operational step 74 entail reversing a grip upon the handle 16 and swinging the handle 16 so that the rounded face 20 strikes the screw 28 to impart a dimple 32 into the sheet of drywall 22, respectively.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pounding, prying, and screwing hand tool comprising:
a handle;
a hammerhead attached to a first end of the handle; and
a screw bit attached to, or selectively attachable to, a second end of the handle, such that the screw bit extends axially from the handle, wherein the handle is configured for grasping in a hand of a user, positioning the user for selectively pounding and prying using the hammerhead and for selectively setting a respective screw using the screw bit.

2. The pounding, prying, and screwing hand tool of claim 1, wherein the hammerhead comprises a claw opposingly positioned to a rounded face, wherein the handle is configured for grasping in the hand of the user, positioning the user for selectively dimpling a sheet of drywall using the rounded face and for removing fasteners by prying with the claw.

3. The pounding, prying, and screwing hand tool of claim 1, wherein the screw bit comprises a Phillips head.

4. The pounding, prying, and screwing hand tool of claim 1, further including:
the screw bit comprising a bit section and a coupling section, the bit section being complementary to the respective screw; and
a coupler attached to the second end of the handle, the coupler being complementary to the coupling section of the screw bit, such that the coupler is positioned for selectively coupling to the coupling section for removably attaching the screw bit to the handle.

5. The pounding, prying, and screwing hand tool of claim 4, wherein the coupler is magnetic and the screw bit is paramagnetic.

6. The pounding, prying, and screwing hand tool of claim 4, wherein the coupler comprises a tube attached to the handle and positioned in a channel extending into the handle, the tube having an inner surface, the inner surface having a hexagonal cross-sectional profile.

7. The pounding, prying, and screwing hand tool of claim 6, wherein the tube is adhesively attached to the handle.

8. The pounding, prying, and screwing hand tool of claim 6, further including:
a segment of the tube extending from the handle, a portion of the segment distal from the handle being externally threaded;
a collar, the collar being internally threaded, such that the collar is complementary to the portion of the segment of the tube; and
an O-ring attached to and positioned in the collar proximate to a first side of the collar, such that the portion of the segment is threadedly insertable into a second side of the collar for compressing the O-ring between the collar and the screw bit for removably attaching the screw bit to the tube.

9. A pounding, prying, and screwing hand tool comprising:
a handle;
a hammerhead attached to a first end of the handle, the hammerhead comprising a claw opposingly positioned to a rounded face, wherein the handle is configured for grasping in a hand of a user, positioning the user for selectively dimpling a sheet of drywall using the rounded face and for removing fasteners by prying with the claw;
a screw bit attached to, or selectively attachable to, a second end of the handle, such that the screw bit extends axially from the handle, wherein the handle is configured for grasping in the hand of the user, positioning the user for selectively pounding and prying using the hammerhead and for selectively setting a respective screw using the screw bit, the screw bit comprising a Phillips head, the screw bit comprising a bit section and a coupling section, the bit section being complementary to the respective screw;
a coupler attached to the second end of the handle, the coupler being complementary to the coupling section of the screw bit, such that the coupler is positioned for selectively coupling to the coupling section for removably attaching the screw bit to the handle, the coupler being magnetic, the screw bit being paramagnetic, the coupler comprising a tube attached to the handle and positioned in a channel extending into the handle, the tube having an inner surface, the inner surface having a hexagonal cross-sectional profile, the tube being adhesively attached to the handle, a segment of the tube extending from the handle, a portion of the segment distal from the handle being externally threaded;
a collar, the collar being internally threaded, such that the collar is complementary to the portion of the segment of the tube; and
an O-ring attached to and positioned in the collar proximate to a first side of the collar, such that the portion of the segment is threadedly insertable into a second side of the collar for compressing the O-ring between the collar and the screw bit for removably attaching the screw bit to the tube.

10. A method of setting a screw and dimpling a sheet of drywall comprising the steps of:
providing a pounding, prying, and screwing hand tool comprising:
a handle,
a hammerhead attached to a first end of the handle, the hammerhead comprising a rounded face, wherein the handle is configured for grasping in a hand of a user, positioning the user for selectively dimpling a sheet of drywall using the rounded face, and
a screw bit attached to, or selectively attachable to, a second end of the handle, such that the screw bit extends axially from the handle, wherein the handle is configured for grasping in a hand of a user, positioning the user for selectively pounding and prying using the hammerhead and for selectively setting a respective screw using the screw bit;
providing a sheet of drywall having at least one screw requiring setting and around which a dimple is required for receiving joint compound;
grasping the handle in a hand;
inserting the screw bit into the screw;
rotating the handle to set the screw;
reversing a grip upon the handle; and
swinging the handle so that the rounded face strikes the screw to impart a dimple into the sheet of drywall.
